(19) United States
(12) Patent Application Publication
(10) Pub. No.: US 2021/0351487 A1
(43) Pub. Date: Nov. 11, 2021

(54) THREE-DIMENSIONAL BRANCH LINE COUPLER

(71) Applicant: Raytheon Company, Waltham, MA (US)

(72) Inventors: Elicia K. Harper, Chelsea, MA (US); Christopher M. Laighton, Boxborough, MA (US); Francois Y. Colomb, Westford, MA (US)

(73) Assignee: Raytheon Company, Waltham, MA (US)

(21) Appl. No.: 16/867,067

(22) Filed: May 5, 2020

(51) Int. Cl. H01P 5/16; H01P 1/18; H01P 3/08

(52) U.S. Cl. CPC H01P 5/16; H01P 3/08; H01P 1/184

(57) ABSTRACT

A branchline coupler structure having a pair of main transmission lines disposed on different horizontal levels of a support structure and a pair of shunt transmission lines, vertically disposed and laterally spaced, and disposed in the support structure. A first one of the pair of shunt transmission lines is coupled between: one region of a first one of the pair of main transmission lines and a first end of a second one of the pair of main transmission line. A second one of the pair of shunt transmission lines is coupled between a second region of the first one of the pair of main transmission lines, laterally spaced from the first region, and a second end of the second one of the main transmission lines.

### TECHNICAL FIELD

This disclosure relates generally to branchline couplers and more particularly to compact branchline couplers.

### BACKGROUND OF THE INVENTION

As is known in the art, one type of analog phase shifter includes a branchline coupler. One such branchline coupler, sometimes also referred to as a reflective coupler or a shunt hybrid combiner, is shown in FIG. 1 to include a pair of main transmission lines and a pair of shunt transmission lines. One analog phase shifter, (FIG. 2) that includes a branchline coupler is described in a paper entitled “Integral analysis of hybrid coupler semiconductor phase shifters” by Kori et al, IEE Proceedings, vol. 134, Pt.H. No. 2. April 1987.

One technique used to adjust phase shift of the branchline coupler type phase shifter is to connect a phase adjusting section connected to each one of the pair of shunt transmission lines as described in a paper entitled “A Low-Loss Voltage-Controlled Analog Phase-Shifter Using Branchline Coupler and Varactor Diodes” by Gupta et al., (Gupta, Nishant, Raghuvir Tomar, and Prakash Bhartia. “A low-loss voltage-controlled analog phase-shifter using branchline coupler and varactor diodes.” Microwave and Millimeter Wave Technology, 2007. ICMMT07. International Conference on. IEEE, 2007). There a pair of varactor diodes is controlled by voltages to adjust the phase shift provided by the phase shifter. Another branchline coupler type phase shifter having a phase adjusting section connected to each one of the pair of shunt transmission lines is shown in FIG. 3A. Here the phase adjusting sections each includes a pair of conductors separated one from and the other; one of the conductors being connected to a ground plane conductor on the bottom of a substrate. The two conductors are connected by a series of bridging, spaced bond wires, as shown. With an input signal applied, the phase at the output is measured and the bond wires are removed one at a time, as shown in FIG. 3B, to thereby change the electrical length of the path through the phase adjusting sections to ground until the desired phase shift is obtained; FIG. 3B showing several of the bond wires removed from the branchline coupler type phase shifter of FIG. 3A.

### SUMMARY OF THE INVENTION

In accordance with the present disclosure a branchline coupler structure is provided, comprising: a support structure; a pair of main transmission lines disposed on different horizontal levels of the support structure; and a pair of shunt transmission lines, vertically disposed and laterally spaced, and disposed in the support structure. A first one of the pair of shunt transmission lines is coupled between: one region of a first one of the pair of main transmission lines and a first end of a second one of the pair of main transmission line. A second one of the pair of shunt transmission lines is coupled between a second region of the first one of the pair of main transmission lines, laterally spaced from the first region, and a second end of the second one of the main transmission lines.

In one embodiment, the branchline coupler structure includes: a pair of phase adjusting sections, each one of the pair of phase shifting sections being coupled to a corresponding one of a pair of shunt transmission line sections through a corresponding one of pair phase shifter section transmission lines, the pair phase shifter section transmission lines being disposed on an upper surface of the support structure. A ground pad is disposed on an upper surface of the support structure, separate from the signal strip conductors of the phase shifter section transmission lines by gaps; and a plurality of electrical conductors, bridging the gaps, disposed successive along over the gaps, each one of the plurality of electrical conductors having one end to connect the ground pad and a second end connected to the phase shifter transmission line sections.

In one embodiment, the branchline coupler structure includes: a second ground pad disposed on an upper surface of the support structure, separate from the signal strip conductors of the pair of phase shifter section transmission lines by a pair of gaps; and a second plurality of electrical conductors, bridging the pair of gaps, disposed successive along over the pair of gaps, each one of the second plurality of electrical conductors having one end connect the second ground pad and a second end connected to the corresponding one of the phase shifter transmission line sections.

In one embodiment, the first-mentioned plurality of electrical conductors and the second plurality of electrical conductors are staggered along the first mentioned gap and a corresponding one of the pair of gaps.

In one embodiment, pair of shunt transmission lines propagate energy with the electric field of such energy being disposed vertically.

In one embodiment, the pair of main transmission lines propagate energy with the electric field of such energy being disposed horizontally.

In one embodiment, a branchline coupler structure is proved comprising: a pair of main transmission lines; a pair of shunt transmission lines, a first one of the pair of shunt transmission lines is coupled between: one region of a first one of the pair of main transmission lines and a first end of a second one of the pair of main transmission line, a second one of the pair of shunt transmission lines is coupled between a second region of the first one of the pair of main transmission lines, laterally spaced from the first region, and a second end of the second one of the main transmission lines; a pair of phase adjusting sections, each one of the pair of phase shifting sections being coupled to a corresponding one of a pair of shunt transmission line sections through a corresponding one of pair phase shifter section transmission lines; a ground pad disposed on an upper surface of the support structure, separate from the signal strip conductors of the phase shifter section transmission lines by gaps; and a plurality of electrical conductors, bridging the gaps, disposed successive along over the gaps, each one of the plurality of electrical conductors having one end to connect the ground pad and a second end connected to one of the phase shifter transmission line sections.

In one embodiment, a second ground pad disposed on an upper surface of the support structure, separate from the signal strip conductors of the pair of phase shifter section transmission lines by a pair of gaps. A second plurality of electrical conductors, bridging the pair of gaps, is disposed successive along over the pair of gaps, each one of the second plurality of electrical conductors having one end connect the second ground pad and a second end connected to the corresponding one of the phase shifter transmission line sections.

In one embodiment. the first-mentioned plurality of electrical conductors and the second plurality of electrical conductors are staggered along the first mentioned gap and a corresponding one of the pair of gaps.

With such an arrangement a compact branchline coupler is provided. Also, the number of phase shifts available is increased by providing the second ground pad.

The details of one or more embodiments of the disclosure are set forth in the accompanying drawings and the description below. Other features, objects, and advantages of the disclosure will be apparent from the description and drawings, and from the claims.

### BRIEF DESCRIPTION OF THE DRAWINGS

FIG. 1 is a schematic diagram of a branchline coupler according to the PRIOR ART;

FIG. 2 is a schematic diagram of a phase shifter using a branchline coupler according to the PRIOR ART;

FIGS. 3A and 3B are perspective views of a phase shifter using a branchline coupler according to the PRIOR ART at various stages in the fabrication thereof according to the PRIOR ART;

FIG. 4 is a perspective view, partially shown in phantom, of a branchline coupler according to the disclosure;

FIG. 4A is the perspective of view, partially shown in phantom, of the branchline coupler of FIG. 4 with a portion thereof removed to show inner layers of the branchline coupler according to the disclosure, such inner portion being encircled by an arrow designated 7-7 and shown in FIG. 7;

FIG. 4B shows the signal conductors used in the branchline coupler of FIG. 4 according to the disclosure;

FIG. 5 is an exploded, perspective sketch showing each one of a plurality of vertically stacked printed circuit boards of the branchline coupler of FIG. 4 according to the disclosure;

FIGS. 5A-5M are top views of each one of the printed circuit boards of FIG. 5 used to form the branchline coupler of FIG. 4 according to the disclosure;

FIG. 6 is a simplified, exploded, diagrammatic schematic sketch of the branchline coupler of FIG. 4 useful in further understanding the arrangement of the printed circuit boards of FIG. 5A-5M of the branchline coupler of FIG. 4 according to the disclosure; and

FIG. 7 is a cross sectional view of the inner portion designated as 7-7 in FIG. 4A of the branchline coupler of FIG. 4 according to the disclosure.

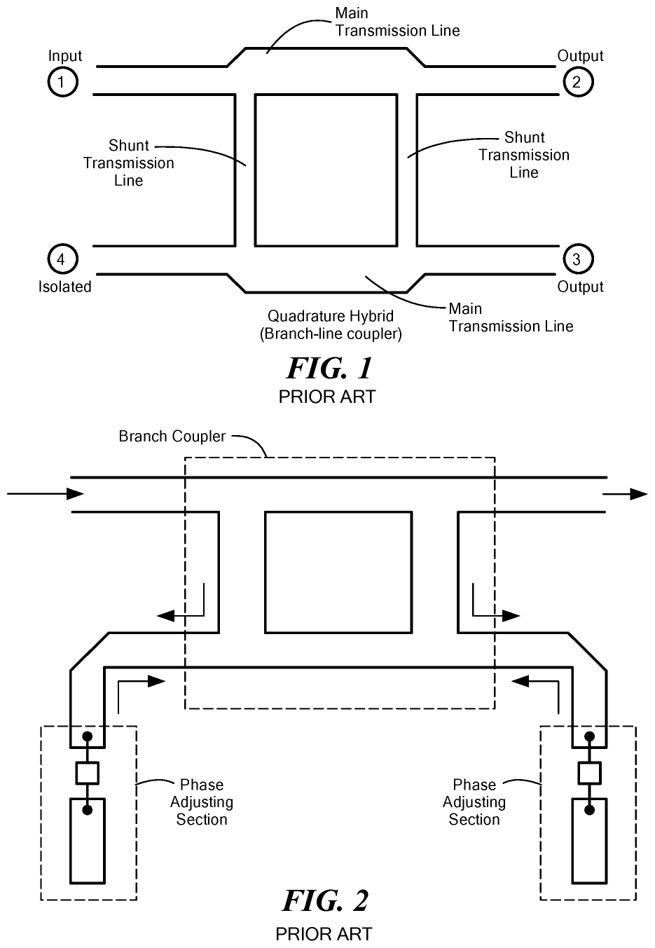

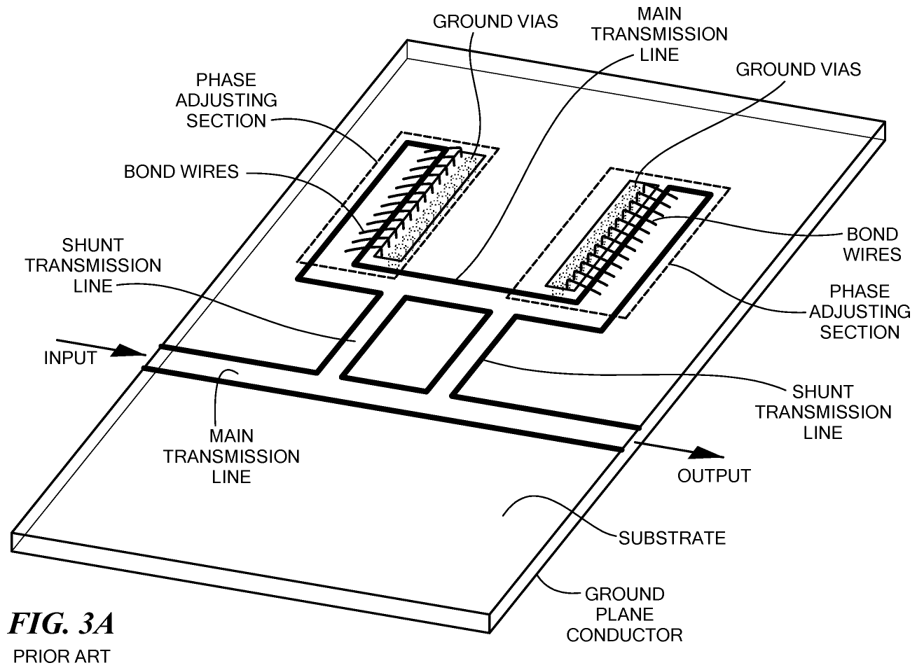

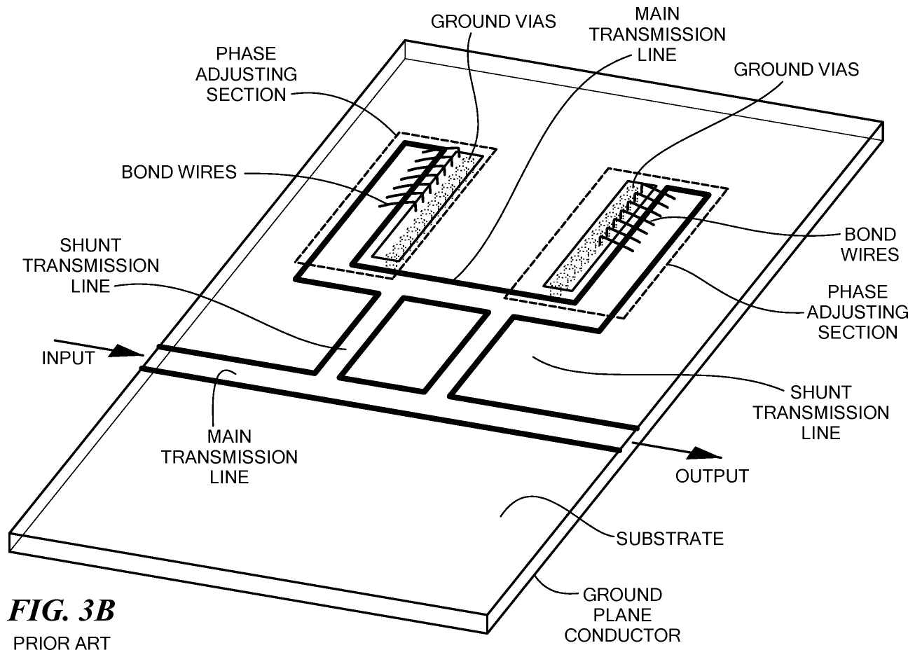

Like reference symbols in the various drawings indicate like elements.

### DETAILED DESCRIPTION

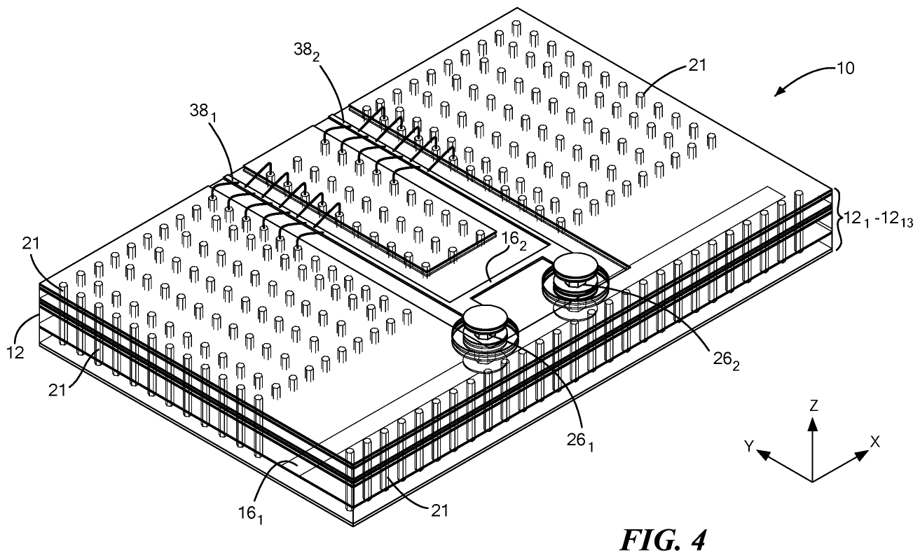

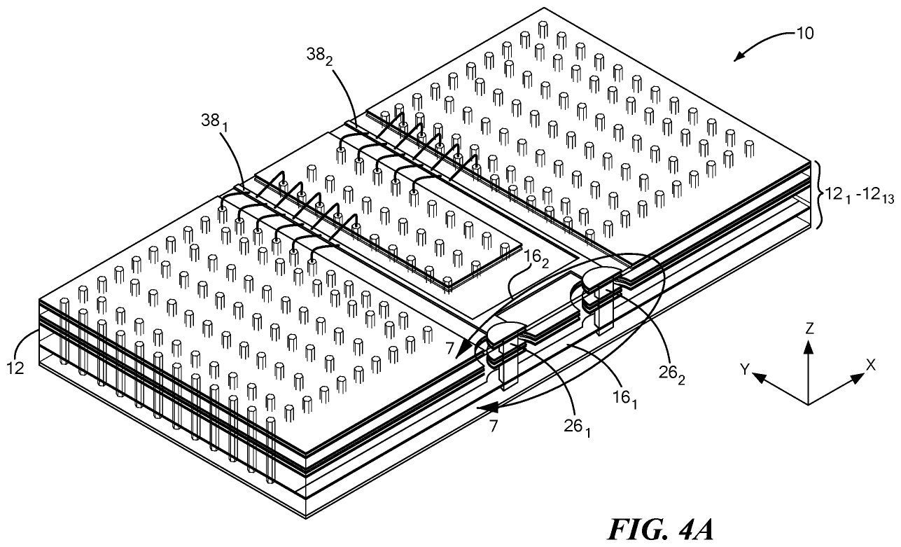

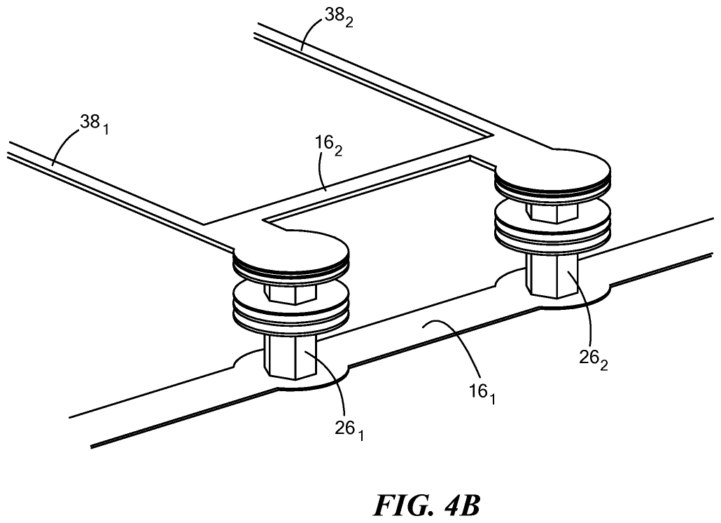

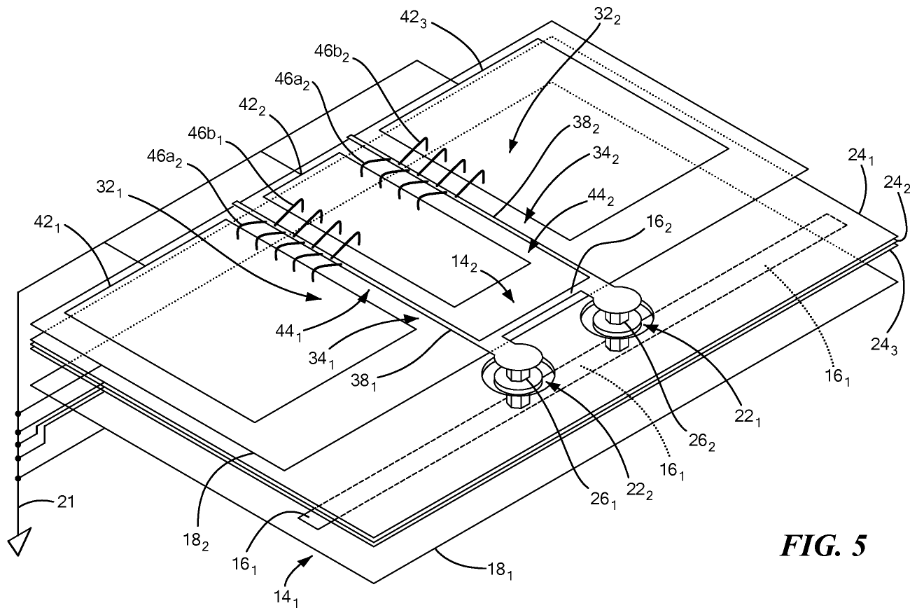

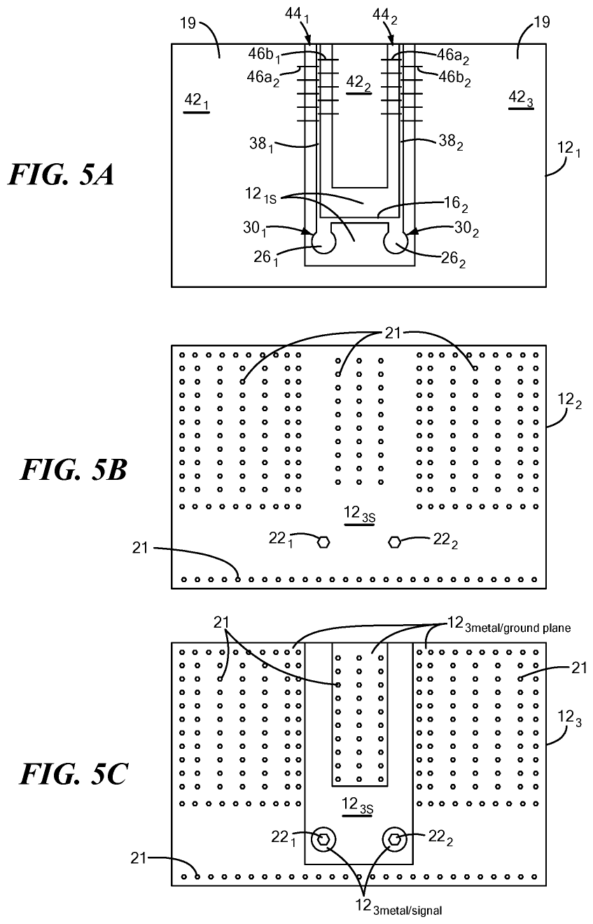

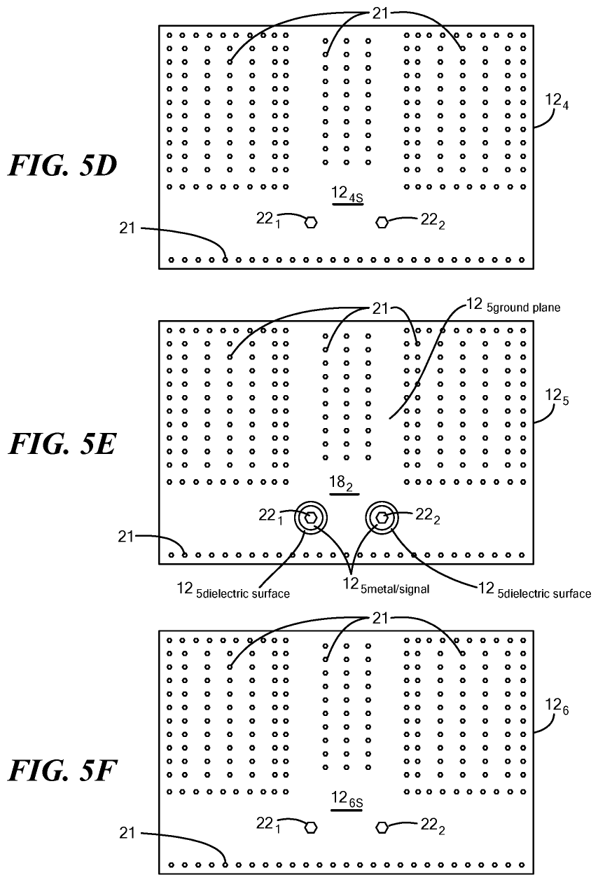

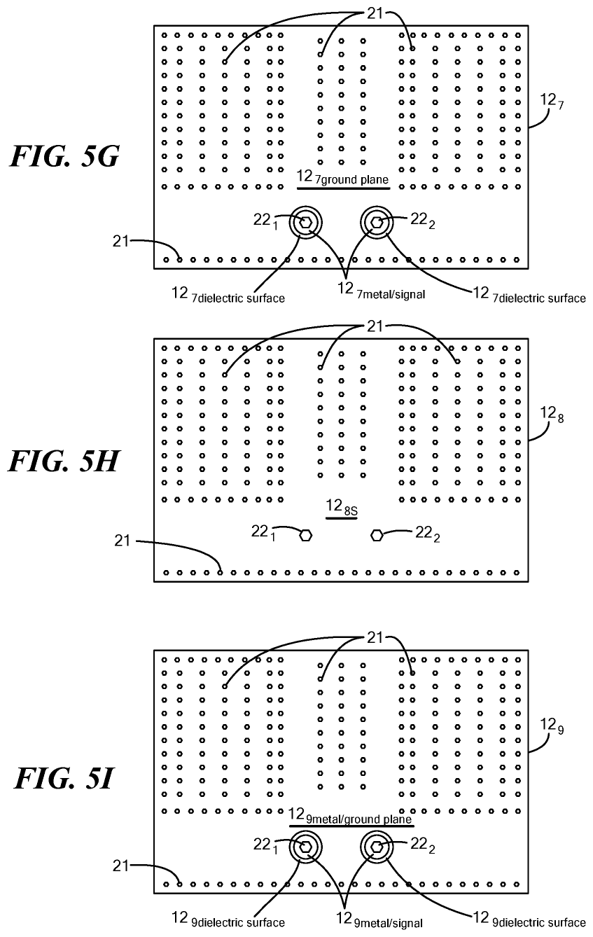

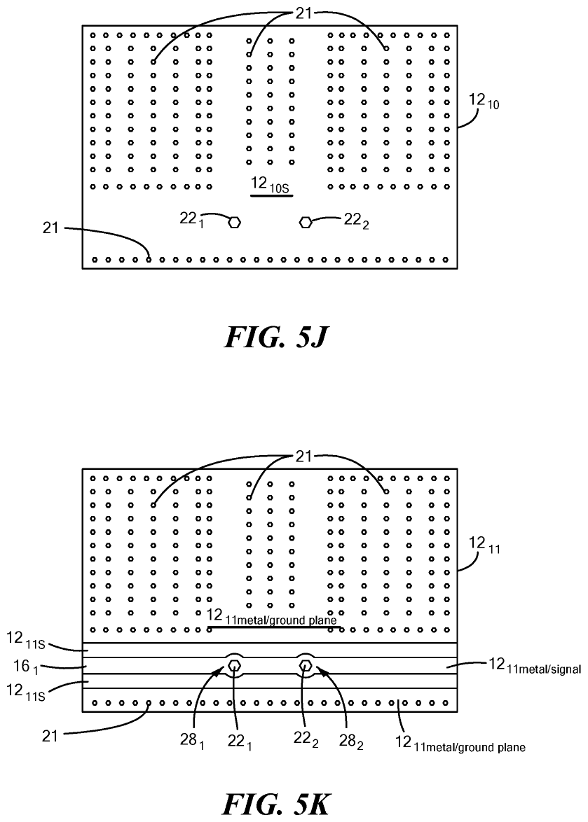

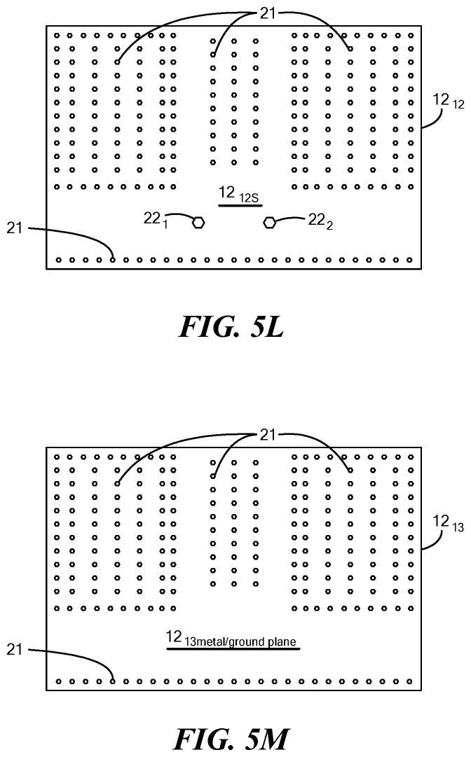

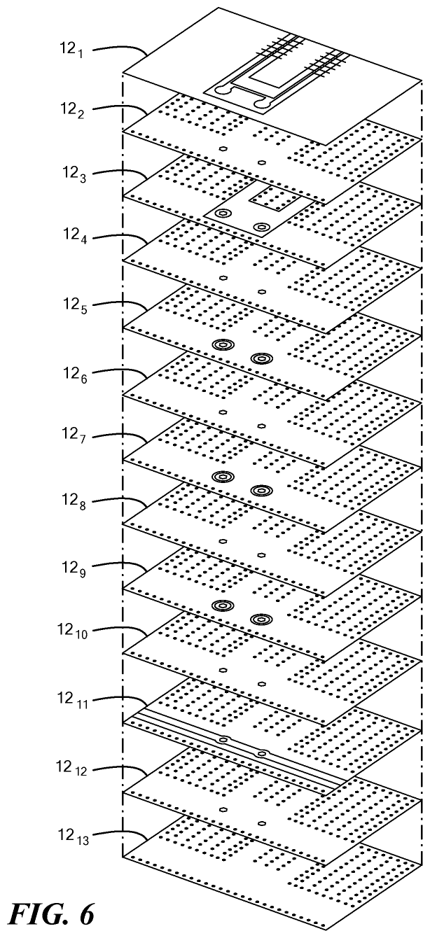

Referring now to FIGS. 4A, 4B and 5, a branchline coupler structure 10 is shown. The branchline coupler structure 10 incudes: a support structure 12 (FIG. 4A) here a dielectric structure comprising a plurality of, here thirteen, planar printed circuit boards 12₁-12₁₃, vertically stacked along the Z-axis, as shown in FIG. 6, the planar surfaces of the boards 12₁-12₁₃ being disposed in horizontal (X-Y) planes, the top view of each one of the plurality of printed circuit boards 12₁-12₁₃ being shown in FIGS. 5A-5M, respectively; the top one of the boards 12₁-12₁₃ being designated as 12₁ and the bottom one of the boards 12₁-12₁₃ being labelled 12₁₃. When the plurality of printed circuits boards 12₁-12₁₃ are bonded together with any conventional dielectric bonding material, not shown, the branchline coupler structure 10 forms, as shown diagrammatically in FIG. 5; the signal strip conductors 16₁,16₂, inner signal conductors 26₁,26₂ and signal strip conductors 38₁,38₂, of the branchline coupler 10, to be described in more detail below, being shown in FIG. 4B.

Referring also to FIGS. 5A-5M, a pair of main transmission lines 14₁, 14₂, (FIG. 5) here microstrip transmission lines, each one having a signal strip conductor 16₁, 16₂, respectively, formed on the upper surface of boards 12₁₁ and 12₁, respectively, as shown in FIGS. 5K and 5A, respectively, and a corresponding, underlying one a pair of ground plane conductors 18₁,18₂, respectively, formed by conductive sheet portions 12_{13 metal/ground plane} and 12_{3 metal/ground plane} on boards 12₁₃ and 12₃, respectively, as shown in FIGS. 5M and 5C, respectively, disposed in the X-Y horizontal plane to support an electric field along the vertical Z-axis disposed, each one of the main transmission lines 14₁, 14₂ being disposed on different horizontal levels of the support structure 12; and a pair of shunt transmission lines, 26₁, 26₂, (FIG. 5) here coaxial type transmission lines 22₁, 22₂, having: (a) grounded outer conductors formed by conductive sheet 24₁, 24₂, 24₃, respectively, formed by conductive sheet portions 12_{5 metal/ground plane}, 12_{7 metal ground plane}, and 12_{9 metal ground plane} on boards 12₅, 12₇ and 12₉, respectively (FIGS. 5E, 5G and 5I, respectively, the conductive sheets being spaced vertically less than a quarter wavelength at the nominal operating wavelength of the branchline coupler in order to appear electrically as a continuous conductor; and inner signal conductors 26₁, 26₂, respectively, formed by conductive signal vias 22₁, and 22₂ formed by conductive portions of conductive sheets on boards, respectively, 12₂-12₁₂ as shown in FIG. 5B through FIG. 5L, the coaxial type transmission lines 22₁, 22₂, extending vertically and laterally spaced, and disposed in the support structure 12 to support an electric field along the X-Y horizontal planes.

A first one of the pair of shunt transmission lines 26₁, 26₂, (FIG. 5) here shunt transmission line 26₁ is coupled between: one region 28₁ on board 12₁₁ (FIG. 5K) of a first one of the pair of main transmission lines 14₁,14₂, here main transmission line 14₁ and a first end 30₁ on board 12₁ (FIG. 5A) of a second one of the pair of main transmission lines 14₁, 14₂, here main transmission line 14₂. A second one of the pair of shunt transmission lines 26₁, 26₂, here shunt transmission line 26 is coupled between a second region 28₂ on board 12₁₁ (FIG. 5K) of the first one of the pair of main transmission lines 14₁,14₂, here main transmission line 14₁ has a region 28₁ laterally spaced from a second region 28₂ on board 12₁₁.

Here the branchline coupler structure 10 includes: a pair of phase adjusting sections, 32₁,32₂, FIG. 5, each one of the pair of phase shifting sections 32₁, 32₂ being coupled to a corresponding one of a pair of shunt transmission line sections 26₁,26₂, respectively and a corresponding one of the second one of the pair of main transmission lines, respectively, at a corresponding one of the regions 28₁,28₂, respectively, as shown, through a corresponding one of pair phase shifter section transmission lines, 34₁,34₂, (FIG. 5) respectively, here microstrip transmission lines, as shown. More particularly, phase shifter section transmission lines, 34₁,34₂, each has a corresponding of a pair of signal strip conductors 38₁,38₂, respectively, disposed on an upper surface of the support structure 10 (board 12₁, FIG. 5A) and extending along the Y-direction. Each one of the pair of signal strip conductors 38₁, 38₂, is disposed above a corresponding one of a pair of ground plane conductors 40₁,40₂, respectively, here provided by a common conductor 31 pattern as shown on board 12₄ as shown in FIG. 5D) and positioned to support a vertical electric field along the Z-axis.

A plurality of, here three electrically connected ground pads 42₁, 42₂, and 42₃, are disposed on an upper surface of the support structure 10 are formed by a patterned electrical conductor 19 formed on board 12₁ (FIG. 5A), as indicted. The three ground pads 42₁, 42₂, and 42₃, are separate from one another by gaps 44₁ and 44₂, as shown, with signal strip conductors 38₁,38₂, respectively, being disposed in gaps 44₁, 44₂, respectively, as shown. There are two sets 46a₁, 46b₁ and 46a₂, 46b₂ of electrical conductors, here bond wires, are staggered across gaps 44₁,44₂, respectively, as shown. One portion of set 46a₁, 46b₁, here set 46a₁ has one end connected to ground pad 42₁ and an opposite end connected to signal strip conductor 38₁ and here set 46b₁ has one end connected to ground pad 42₂ and an opposite end connected to signal strip conductor 38₁. It is noted that the electrical conductors in set 46a₁ and set 46b₁ are disposed successive along over the gap 44₁ with each one the conductors in set 46a₁ being staggered with respect to the each one of the conductors in set 46b₁, as shown. To put it another way, each one of the conductors in set 46b₁ is disposed between a pair of the conductors in set 46a₁, as shown. Likewise, it is noted that the electrical conductors in set 46a₂ and set 46b₂ are disposed successive along over the gap 44₂ with each one the conductors in set 46a₂ being staggered with respect to the each one of the conductors in set 46b₂, as shown. To put it another way, each one of the conductors in set 46b₂ is disposed between a pair of the conductors in set 46a₂, as shown.

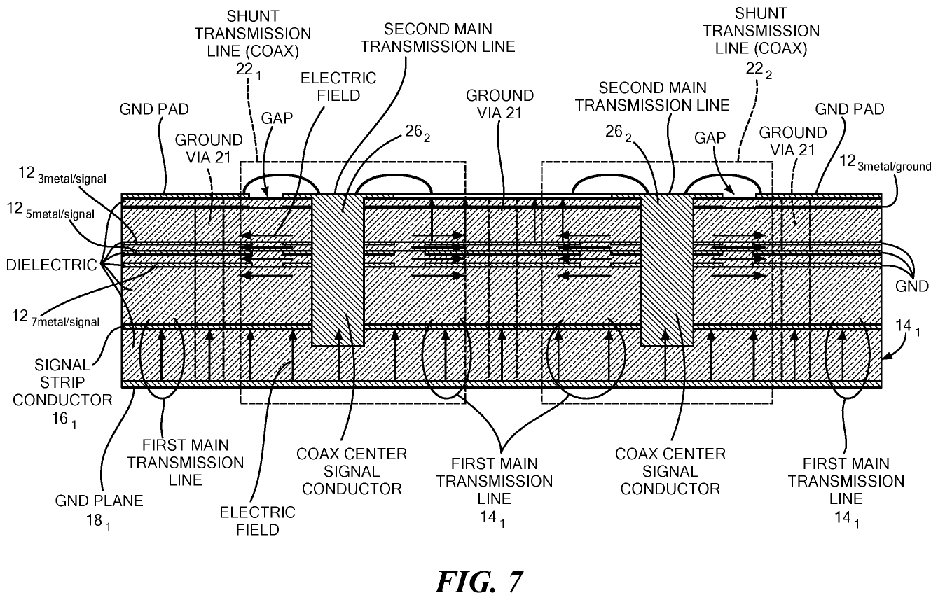

The ground plane conductors on printed circuit boards 12₁, 12₃, 12₅, 12₇, 12₉, 12₁₁ and 12₁₃-(FIGS. 5A, 5C, 5E, 5G, 5I, 5K and 5M, respectively), and the three ground pads 42₁,42₂, and 42₃ on board 12₁ (FIG. 5A), are connected together with conductive ground vias 21, as shown in FIGS. 5A-5M. Boards 12₂, 12₄, 12₆, 12₈, 12₁₀, 12₁₂ (FIGS. 5B, 5D, 5F, 5H, 5J, and 5L), have conductive vias 21 with boards 12₄, 12₆, 12₈,12₁₀ and 12₁₂ also having portions of the center signal conductor of the coaxial shunt transmission lines 22₁, 22₂ as shown in FIG. 7.

The boards 12₁-12₁₃ are formed as shown above and described above in FIGS. 5A-M except for the ground vias 21 and inner signal conductors 26₁, 26₂. The formed boards 12₁-12₁₃ are then stacked and bonded together with any conventional dielectric bonding material, not shown. The ground vias 19 and conductive vias of the inner signal conductors 26₁, 26₂ are formed by first etching or drilling holes in the bonded structure from the bottom or backside of the bonded structure vertically through such structure starting from the back of board 12₁₃ and then then filling the holes with a suitable electrically conductive material. In order to prevent the conductive material from electrically connecting the inner signal conductors 26₁, 26₂. To the ground plane conductor on board 12₁₃, the portion of the inner signal conductors 26₁, 26₂, conductive material of the inner signal conductors 26₁, 26₂ making such connection are removed by back-drilling or by timed etching for example and removed conductive material is replaced with a dielectric material.

Thus, in FIG. 5A, board 12₁: numerical designation 19 is conductive sheet patterned to form pads 42₁,42₂ and 42₃; signal strip conductors 38₁,38₂, main transmission line signal 14₂ strip conductor 16₂; top portions of inner signal conductors 26₁, 26₂; a first and second ends of the main transmission line 14₂₁ signal strip conductors 30₁, 30₂; exposed portion of the surface of the dielectric portions of board 12₁ being designed 12_{1S}.

In FIG. 5B, board 12₂: dielectric surface of board 12_{2S} and conductive vias 12_{2signal} for center signal conductors of coaxial shunt transmission 22₁, 22₂ exposed portions of the dielectric surface being designated 12_{2S}.

In FIG. 5C, board 12₃: patterned conductor 12_{3 ground plane} serves as a ground plane conductor 18₂ for signal strip conductor 16₂ of the main transmission line 14₂ and as the ground plane conductors 40₂ for strip conductors 38₂ of the phase shifter transmission line 34₂; numerical designation 12_{3S} is the dielectric exposed surface portions of the dielectric board 12₃, numerical designation 12_{3 metal/signal} designating an outer portion of the inner signal conductors 26₁, 26₂.

In FIG. 5D, board 12₄: numerical designation 12_{4S} is the exposed portions of the surface of board 12₄.

In FIG. 5E, board 12₅: numerical designation 12_{5 ground plane} is patterned conductor providing a ground plane with exposed dielectric portions of the dielectric board 12₅ being designated 12_{5S}; numerical designation 12_{5 metal/signal} designates an outer portion of the inner signal conductors 26₁, 26₂.

In FIG. 5F, board 12₆: numerical designation 12_{6S} being portions of the surface of dielectric board 12₆.

In FIG. 5G, board 12₇: numerical designation 12_{7 ground plane} is patterned conductor providing a ground plane with exposed dielectric portions of the dielectric board 12₇ being designated 12_{7S}; numerical designation 12_{7 metal/signal} designates an outer portion of the inner signal conductors 26₁, 26₂.

In FIG. 5H, board 12₈: numerical designation 12_{8S} being portions of the surface of dielectric board 12₈.

In FIG. 5I, board 12₉: numerical designation 12_{9 ground plane} designates patterned conductor providing a ground plane with exposed dielectric portions of the dielectric board 12₉ being designated 12_{9S}; numerical designation 12_{9 metal/signal} designating an outer portion of the inner signal conductors 26₁, 26₂.

In FIG. 5J, board 12₁₀, numerical designation 12_{10S} being portions of the surface of dielectric board 12₁₀.

In FIG. 5K, board 12₁₁, numerical designation 12_{11 ground plane} designates patterned conductor providing a ground plane with exposed dielectric portions of the dielectric board 12₁₁ being designated 12_{11S}; numerical designation 12_{1 metal/signal} designating the signal strip conductor 16₁ of the main transmission line 14₁.

In FIG. 5L, board 12₁₂, numerical designation 12_{12S} designates portions of the surface of dielectric board 12₁₂.

In FIG. 6M, board 12₁₃, numerical designation 12₁₃ designating the ground plane conductor 18₁ of the main transmission line 14₁.

A number of embodiments of the disclosure have been described. Nevertheless, it will be understood that various modifications may be made without departing from the spirit and scope of the disclosure. For example, the phase shifting section need not use bonding wires but techniques described in U.S. Pat. No. 10,243,246 Issued Mar. 26, 2019, entitled “Phase Shifter Including a Branchline Coupler Having Phase Adjusting Sections Formed By Connectable Conductive Pads”, Inventors Laighton et al., assigned to the same assignee as the present invention may be used. Further, the coaxial, vertical, shunt transmission line may be formed by arranging a plurality of vertical columns of conductor closely spaced circumferentially around a signal center conductor as described in U.S. Pat. No. 9,887,195 Issued Feb. 6, 2018, Inventors Drab et al., assigned to the same assignee as the present invention. Accordingly, other embodiments are within the scope of the following claims.

1. A branchline coupler structure, comprising:
a support structure;
a pair of main transmission lines disposed on different horizontal levels of the support structure;
a pair of shunt transmission lines, vertically disposed and laterally spaced, and disposed in the support structure;
wherein a first one of the pair of shunt transmission lines is coupled between: one region of a first one of the pair of main transmission lines and a first end of a second one of the pair of main transmission line;
wherein a second one of the pair of shunt transmission lines is coupled between a second region of the first one of the pair of main transmission lines, laterally spaced from the first region, and a second end of the second one of the main transmission lines; and
wherein the pair of shunt transmission lines propagate energy vertically with the electric field of such energy being disposed horizontally.

2. The branchline coupler structure recited in claim 1 including:
a pair of phase adjusting sections, each one of the pair of phase shifting sections being coupled to a corresponding one of a pair of shunt transmission line sections through a corresponding one of pair phase shifter section transmission lines, the pair phase shifter section transmission lines being disposed on an upper surface of the support structure:
a ground pad disposed on an upper surface of the support structure, separate from the signal strip conductors of the phase shifter section transmission lines by gaps; and
a plurality of electrical conductors, bridging the gaps, disposed successive along over the gaps, each one of the plurality of electrical conductors having one end to connect the ground pad and a second end connected to one of the phase shifter transmission line sections.

3. The branchline coupler structure recited in claim 2 including:
a second ground pad disposed on an upper surface of the support structure, separate from the signal strip conductors of the pair of phase shifter section transmission lines by a pair of gaps;
a second plurality of electrical conductors, bridging the pair of gaps, disposed successive along over the pair of gaps, each one of the second plurality of electrical conductors having one end connect the second ground pad and a second end connected to the corresponding one of the phase shifter transmission line sections.

4. The branchline coupler structure recited in claim 3 wherein the first-mentioned plurality of electrical conductors and the second plurality of electrical conductors are staggered along the first mentioned gap and a corresponding one of the pair of gaps.

5. (canceled)

6. The branchline coupler structure recited in claim 1 wherein the pair of main transmission lines propagate energy horizontally with the electric field of such energy being disposed vertically.

7. (canceled)

8. A branchline coupler structure, comprising:
a support structure;
a pair of main transmission lines disposed on different horizontal levels of the support structure;
a pair of shunt transmission lines, vertically disposed and laterally spaced, and disposed in the support structure;
wherein a first one of the pair of shunt transmission lines is coupled between: one region of a first one of the pair of main transmission lines and a first end of a second one of the pair of main transmission line;
wherein a second one of the pair of shunt transmission lines is coupled between a second region of the first one of the pair of main transmission lines, laterally spaced from the first region, and a second end of the second one of the main transmission lines; and wherein the pair of main transmission lines propagate energy horizontally with the electric field of such energy being disposed vertically.

9. A branchline coupler structure, comprising:
a pair of main transmission lines;
a pair of shunt transmission lines, a first one of the pair of shunt transmission lines is coupled between: one region of a first one of the pair of main transmission lines and a first end of a second one of the pair of main transmission line, a second one of the pair of shunt transmission lines is coupled between a second region of the first one of the pair of main transmission lines, laterally spaced from the first region, and a second end of the second one of the main transmission lines;
a pair of phase adjusting sections, each one of the pair of phase shifting sections being coupled to a corresponding one of a pair of shunt transmission line sections through a corresponding one of pair phase shifter section transmission lines;
a ground pad disposed on an upper surface of the support structure, separate from the signal strip conductors of the phase shifter section transmission lines by gaps; and
a plurality of electrical conductors, bridging the gaps, disposed successive along over the gaps, each one of the plurality of electrical conductors having one end to connect the ground pad and a second end connected to one of the phase shifter transmission line sections.

10. The branchline coupler structure recited in claim 9 including:
a second ground pad disposed on an upper surface of the support structure, separate from the signal strip conductors of the pair of phase shifter section transmission lines by a pair of gaps;
a second plurality of electrical conductors, bridging the pair of gaps, disposed successive along over the pair of gaps, each one of the second plurality of electrical conductors having one end connect the second ground pad and a second end connected to the corresponding one of the phase shifter transmission line sections.

11. The branchline coupler structure recited in claim 10 wherein the first-mentioned plurality of electrical conductors and the second plurality of electrical conductors are staggered along the first mentioned gap and a corresponding one of the pair of gaps.
